(19) United States
(12) Patent Application Publication
(10) Pub. No.: US 2020/0021553 A1
(43) Pub. Date: Jan. 16, 2020

(54) MESSAGING SYSTEM

(71) Applicant: TALKIN THINGS Sp. z o.o., Warsaw (PL)

(72) Inventor: Marcin Pilarz, Warsaw (PL)

(21) Appl. No.: 16/507,830

(22) Filed: Jul. 10, 2019

Related U.S. Application Data
(60) Provisional application No. 62/696,319, filed on Jul. 10, 2018.

(51) Int. Cl. H04L 12/58; G06K 7/10; H04W 4/12; G06T 19/00

(52) U.S. Cl. CPC H04L 51/32; G06K 7/10237; H04L 51/046; G06T 19/006; H04W 4/12

(57) ABSTRACT

A user records a message on a mobile device which stores the message in the cloud. When a unique NFC tag affixed to a product is tapped by the mobile device, the message is assigned to the product NFC tag. The product is then transferred to an intended recipient. When the recipient's mobile device taps the NFC tag, the message is downloaded from the cloud to the recipient's mobile device.

### RELATED APPLICATIONS

This application claims the benefit of Provisional Application No. 62/696,319, filed Jul. 10, 2018, the entirety of which is incorporated herein by reference.

### BACKGROUND OF THE INVENTION

### 1. Field of the Invention

This invention relates to personal messaging and more specifically to employment of consumer product tags for delivery or exchange of social messages.

### 2. Atecedents of the Invention

The sale of products through packaging has been promoted in various manners. Initially, package design and configuration have been employed. Further discount coupons have been attached to the outside of a package and promotional items, such as toys, have been included inside packages. Attempts at product promotion also included prize award notifications inside packages, such as inside a bottle cap.

There was a need, however, to further advance product promotion through social media employing enhanced packaging.

### SUMMARY OF THE INVENTION

A mobile messaging application interacts with a unique NFC tag, QR code, watermark, etc., affixed to a product, its container or packaging. When a user records a message on a mobile device having a mobile messaging application in accordance with the invention, the message is stored in the cloud. When the NFC tag is tapped by the mobile device, the message is assigned to the product NFC tag.

The product is then transferred to the intended message recipient whose mobile device includes a mobile messaging application in accordance with the invention. When the recipient's mobile device taps the NFC tag, the message is downloaded from the cloud to the recipient's mobile device.

In an alternate embodiment, the recipient receives a notification through email, SMS, social media, etc., comprising a link for accessing the message. Then recipient then purchases a product having a tag assigned to the marketing campaign or program associated with the user's product. When the recipient taps the product tag with a mobile device having a mobile messaging application in accordance with the invention, the message is accessed from the cloud.

From the foregoing compendium, it will be appreciated that an aspect of the present invention is to provide a messaging system of the general character described which is not subject to the aforementioned disadvantages of the antecedents of the invention.

A feature of the present invention is to provide a messaging system of the general character described which promotes the sale of products.

A consideration of the present invention is to provide a messaging system of the general character described which facilitates secure communications.

Another aspect of the present invention is to provide a messaging system of the general character described which is easy to use.

An additional feature of the present invention is to provide a messaging system of the general character described which achieves advertising objectives while minimizing costs.

A further consideration of a messaging system of the general character described which utilizes cloud storage for memory conservation.

Other aspects, features and considerations of the present invention in part will be obvious and in part will be pointed out hereinafter.

With these ends in view, the invention finds embodiment in various combinations of elements, arrangements of parts and series of steps by which the above-mentioned aspects, features and considerations and certain other aspects, features and considerations are attained, or with reference to the accompanying drawings and the scope of which will be more particularly pointed out and indicated in the appended claims.

### BRIEF DESCRIPTION OF THE DRAWINGS

In the accompanying drawings, wherein some of the various possible exemplary embodiments of the invention are shown:

FIG. 1 is a pictographic representation of various steps employed in the messaging system of the present invention;

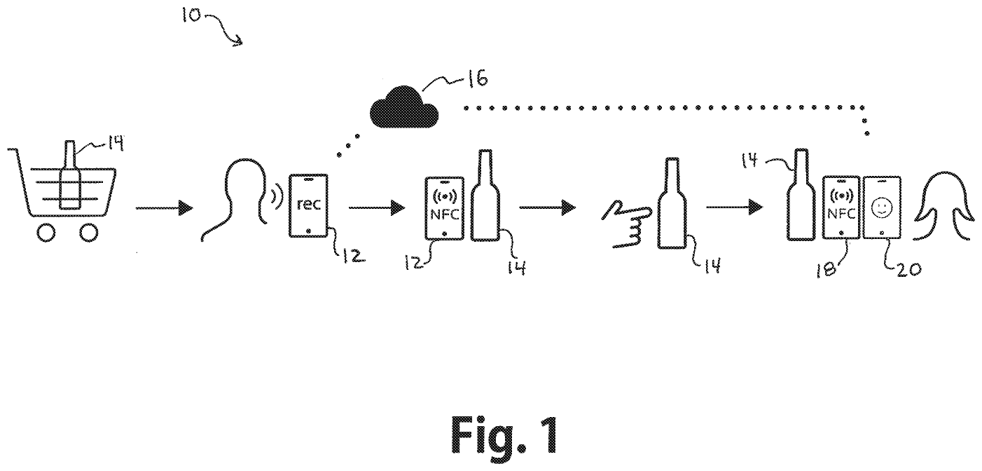

FIG. 2 is a pictographic representation of alternate steps employed in the messaging system of the present invention; and

FIG. 3 is a flow routine depicting various screen shots of the mobile application in accordance with the invention:

### DESCRIPTION OF THE INVENTION

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements.

Moreover, where certain elements of the present invention can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein.

Applicant does not intend for any term in the specification or claims to be ascribed an uncommon or special meaning unless explicitly set forth as such. Further, the present invention encompasses present and future known equivalents to the known components referred to herein by way of illustration.

With reference now to the drawings wherein the reference numeral 10 denotes a generally a messaging system in accordance with the invention. A user (message sender) (is equipped with a mobile device, 12 e.g. smartphone, etc., having a messaging application in accordance with the invention. The user purchases a product 14 having a container, a label or packaging with a unique configuration, e.g., an NFC tag, a QR code, a watermark, etc.

The user then opens the messaging application and records a message which is uploaded to the cloud 16. The message may comprise video, voice, text or images or combinations thereof. The NFC tag on the label or packaging of the product 14 is then tapped with the mobile device 12 to register the NFC tag with the stored message.

The product 14 now comprises a link for accessing the message and is then delivered to an intended message recipient having a mobile device 18 with a messaging application in accordance with the invention. When the recipient taps the NFC tag on the package of the product 14, the message downloads to the device 18, displays on a screen 20 of the device 18 and/or is audibly played.

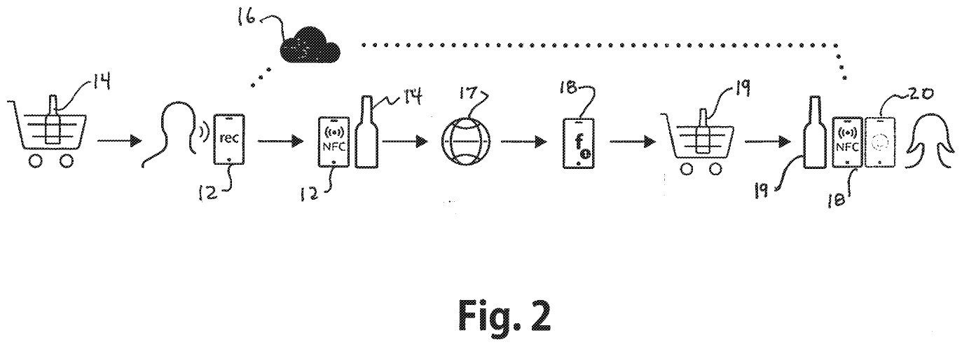

In a variant system illustrated in FIG. 2, like numerals have been employed to denote the same components heretofore disclosed. A user is equipped with a mobile device, 12 e.g. smartphone, etc., having a messaging application in accordance with the invention. The user purchases a product 14 having a unique NFC tag, QR code, watermark, etc., affixed to a label or packaging compatible with a messaging system promotional program.

The user then opens the messaging application and records a message which is uploaded to the cloud 16. The message may comprise video, voice, text or images or combinations thereof. The NFC tag on the label or packaging of the product 14 is then tapped with the mobile device 12 to register the NFC tag with the stored message. The user then enters recipient ID information and a link for accessing the message. The link is then transmitted to the recipient's mobile device 18 having a messaging application in accordance with the invention through SMS, email, social media, WhatsApp, etc., via the web 17 or other communications system.

The recipient purchases a product 19 compatible with the messaging system promotional program. When the recipient taps the NFC tag on the package of the product 19, the mobile device 18, the message downloads to the recipient's device 18, displays on a screen 20 of the device 18 and/or is audibly played.

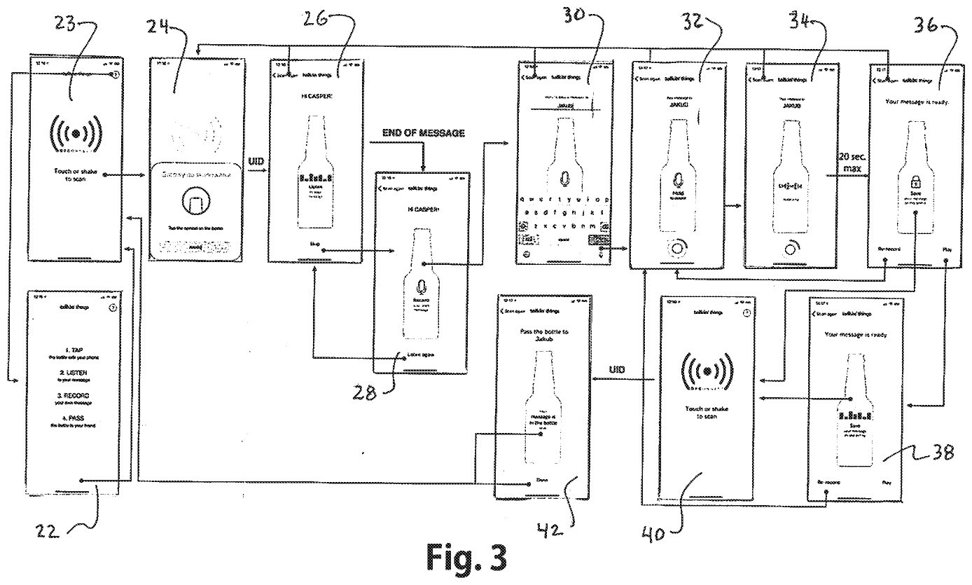

Referring now to FIG. 3 wherein flow routine depicting various screen shots of the mobile application is illustrated, in a first screen 23, instructions are displayed for the user to open the messaging application, e.g. by touching the screen or shaking the device. If the user needs additional or further instructions, the user is directed to a screen 22. After the messaging application has opened, a screen 24 opens wherein the user is instructed to tap the NFC tag on the package of the product 14 to play a prerecorded message such as instructions or an advertisement from the product manufacturer, as indicated at a screen 26. When the message ends, the user has the option to replay, or proceed with recording a message, as indicated at a screen 28.

The user then enters recipient identification information in the screen 30 and proceeds to enter a recording cycle by holding a key in screen 32. Instructions to record appear in the subsequent screen 34. After a recording time limit has passed, the user has the option of saving the recording or rerecording, as indicated in a screen 38. The user has the option of saving, playing back or rerecording in screen 38.

When the message is saved, it is uploaded to the cloud. The user then touches the mobile device to the unique NFC tag on the package of the product 14 to assign the recorded message stored in the cloud to the specific product package having the unique NFC tag, as instructed in the screen 40. In the following screen 42, the user receives confirmation that the message has been associated with the NFC tag affixed to the product 14.

After a recipient receives the product 14, the recipient taps the NFC tag with the recipient's mobile device; the recorded message downloads to the recipient's device with the screens on the recipient's device proceeding as in FIG. 3 with a prerecorded message comprising the message recorded by the user and may continue thereafter with recording a new message.

In a further embodiment, a user purchases a product having a configuration, e.g., a label packaging or container which is not unique and which does not include a unique tag or marking. The user records a message which might comprise a still or motion picture of a person, scene or object with a mobile device having an augmented reality application.

The recorded message is assigned to the configuration which is hardcoded in the augmented reality software together with a unique link. The link is transmitted to the recipient and directs the recipient to a microsite containing a dedicated mobile application for download. After the recipient installs the dedicated mobile application and purchases the same product, the packaging is scanned and recognized by the recipient's augmented reality mobile application. The recorded message taken by the user is then downloaded from the cloud and incorporated into the configuration of the product.

Thus it will be seen that there is provided a messaging system which achieves the various aspects, features and considerations of the present invention as is well suited to meet the conditions of practical use.

Having described the preferred embodiments of the invention, it will now become apparent to one of ordinary skill in the art that other embodiments incorporating the concept may be used. Moreover, those of ordinary skill in the art will appreciate that the embodiments of the invention described herein can be modified to accommodate and/or comply with changes and improvements in the applicable technology and standards referred to herein.

Variations, modifications, and other implementations of what is described herein can occur to those of ordinary skill in the art without departing from the spirit and the scope of the invention as claimed. It is felt therefore that these embodiments should not be limited to the disclosed embodiment but rather should be limited only by the spirit and scope of the appended claims.

Having thus described the invention, there is claimed as new and desired to be secured by Letters Patent:

1. A system of messaging between a first person and a second person, the system including a consumer product having a unique tag or mark readable by a mobile device, the first person having a mobile device and the second person having a mobile device, the system comprising the following steps:
a) the first person recording a message to the second person on the first person's mobile device,
b) storing the message in the cloud,
c) associating the message with the tag or mark by placing the first person's mobile device in communication with the tag or mark,
d) transferring the consumer product to the second person, and
e) downloading the recorded message from the cloud to the second person's mobile device by placing the second person's mobile device in communication with the tag or mark.

2. The system of messaging in accordance with claim 1 wherein the tag or mark is selected from the group consisting of an NFC tag, a QR code or a watermark.

3. The system of messaging in accordance with claim 1 wherein the tag or mark comprises an NFC tag, step c) is performed by tapping the first person's mobile device against the NFC tag and step e) is performed by tapping the second person's mobile device against the NFC tag.

4. A system of messaging between a first person and a second person, the system including a consumer product having a unique tag or mark readable by a mobile device, the first person having a mobile device and the second person having a mobile device, the system comprising the following steps:
a) the first person recording a message to the second person on the first person's mobile device,
b) storing the message in the cloud,
c) associating the message with the tag or mark by placing the first person's mobile device in communication with the tag or mark,
d) transferring a link for accessing the message to the second person, and
e) downloading the recorded message from the cloud to the second person's mobile device.

5. The system of messaging between a first person and a second person in accordance with claim 4 wherein the link comprises the consumer product having the unique tag or mark readable by a mobile device.

6. The system of messaging between a first person and a second person in accordance with claim 4 wherein the link is transmitted to the second person's mobile device through SMS, email, social media or other web based communication.

7. The system of messaging between a first person and a second person in accordance with claim 4 wherein step e) is performed by the second person purchasing a second consumer product having a tag or mark compatible with the consumer product having the unique tag or mark and placing the second person's mobile device in communication with the tag or mark of the second consumer product.

8. The system of messaging in accordance with claim 5 wherein the tag or mark comprises an NFC tag, step c) is performed by tapping the first person's mobile device against the NFC tag and step e) is performed by tapping the second person's mobile device against the NFC tag.

9. The system of messaging between a first person and a second person in accordance with claim 4 wherein the tag or mark is selected from the group consisting of an NFC tag, a QR code or a watermark.

10. The system of messaging between a first person and a second person in accordance with claim 6 wherein the tag or mark is selected from the group consisting of an NFC tag, a QR code or a watermark.

11. A system of messaging between a first person and a second person, the system including a consumer product having a configuration readable by a mobile device, the first person having a mobile device and the second person having a mobile device, the system comprising the following steps:
a) the first person recording a message to the second person on the first person's mobile device,
b) storing the message in the cloud,
c) assigning the message to the configuration,
d) transferring a link for accessing the message to the second person, and
e) downloading the message from the cloud to the second person's mobile device.

12. The system of messaging between a first person and a second person in accordance with claim 11 wherein the configuration is selected from the group consisting of an NFC tag, a QR code or a watermark.

13. The system of messaging between a first person and a second person in accordance with claim 11 wherein the product configuration comprises an image, the first person mobile device includes an augmented reality mobile application comprising software, the message of step a) comprises an audio message, a still picture of a person, scene or object or a motion picture of a person, scene or object or combinations thereof, and step c) includes assigning the message to the product configuration which is hardcoded in the augmented reality software together with the link.

14. The system of messaging between a first person and a second person in accordance with claim 13 including the steps of the second person utilizing the link to download augmented reality software on the second person's mobile device, acquiring a consumer product having a configuration similar or identical to the configuration read by the first person's mobile device, utilizing the second person's mobile device to read the configuration on the acquired consumer product and downloading the recorded message.
